(19) United States
(12) Patent Application Publication
(10) Pub. No.: US 2016/0297952 A1
(43) Pub. Date: Oct. 13, 2016

(54) POLYMER CARBON NANOTUBE COMPOSITE

(71) Applicant: KING ABDULLAH UNIVERSITY OF SCIENCE AND TECHNOLOGY, Thuwal (SA)

(72) Inventors: Ye Chen, Thuwal (SA); Jing Tao, Thuwal (SA); Lin Deng, Thuwal (SA); Niveen Khashab, Thuwal (SA)

(73) Assignee: KING ABDULLAH UNIVERSITY OF SCIENCE AND TECHNOLOGY, Thuwal (SA)

(21) Appl. No.: 15/036,411

(22) PCT Filed: Nov. 13, 2014
(86) PCT No.: PCT/IB2014/003274

§ 371 Date: May 12, 2016

Related U.S. Application Data
(60) Provisional application No. 61/903,634, filed on Nov. 13, 2013.

(51) Int. Cl. C08K 9/04; C08K 3/04

(52) U.S. Cl. CPC C08K 9/04; C08K 3/04

(57) ABSTRACT

A polymer composite can include carbon nanotubes.

### CLAIM OF PRIORITY

This application claims priority from U.S. Provisional Patent Application No. 61/903,634, filed Nov. 13, 2013, which is incorporated by reference in its entirety.

### FIELD OF THE INVENTION

The invention relates to polymer composite materials.

### BACKGROUND

Polymeric materials can be used in a variety of circumstances when the properties of the polymer match the design needs. However, there are some properties of polymers that cannot be accessed directly from base polymeric materials.

### SUMMARY

In one aspect, a polymer composite can include a plurality of carbon nanotubes dispersed in a solid polymer matrix. The resistivity of the polymer composite can be between 1.0×10⁶ Ω·cm and 1.0×10³ Ω·cm. The percentage of the plurality of carbon nanotubes in the composite can be less than 10% by weight. The percentage of the plurality of carbon nanotubes in the composite can be less than 2% by weight. The solid polymer matrix can be insulating.

In certain embodiments, the plurality of carbon nanotubes can be uniformly dispersed in the polymer. The polymer can include polycarbonate, polyvinyl chloride, polyetherimide, poly(methyl methacrylate), polystyrene, or polyetheretherketone, or a mixture thereof.

In certain embodiments, the plurality of carbon nanotubes can be functionalized. The plurality of carbon nanotubes can be covalently functionalized, or non-covalently functionalized.

In one aspect, a method for forming a solid polymer composite can include dispersing a plurality of carbon nanotubes in a polymer matrix to form a polymer carbon nanotube composite. The polymer matrix can be insulating. The resistivity of the polymer carbon nanotube composite can be between 1.0×10⁶ Ω·cm and 1.0×10³ Ω·cm.

In certain embodiments, the method can include dissolving a polymer into a solvent to form a first solution; dispersing a plurality of carbon nanotubes containing a carboxyl group into the solvent separately under sonication to form a second solution; mixing the first solution and the second solution to form a first mixture; treating the first mixture under sonication; and drying the first mixture by removing the solvent.

In certain embodiments, the plurality of carbon nanotubes can be functionalized. The functionalization of the plurality of carbon nanotubes can be non-covalent. The method can include contacting the plurality of carbon nanotubes with a compound having an amine moiety to form a second mixture, wherein the amine associates with carboxyl group on the sidewalls of the plurality of carbon nanotubes; heating the second mixture;

and separating the plurality of carbon nanotubes from the mixture. The compound can have an amine moiety includes octadecylamine.

In certain embodiments, the functionalization of the plurality of carbon nanotubes can be covalent. The method can include contacting the plurality of carbon nanotubes with a compound containing at least one oxide moiety and one halide moiety, wherein the compound reacts with the sidewalls of the plurality of carbon nanotubes to form an acyl halide moiety; separating the plurality of carbon nanotubes having the acyl halide moiety from the solution; contacting the separated plurality of carbon nanotubes that contain the acyl halide moiety with a compound having an amine moiety, wherein the acyl halide moiety reacts with the amine moiety to form an amide group on the sidewalls of the plurality of carbon nanotubes. The compound can contain at least one oxide moiety and one halide moiety includes oxalyl chloride.

In certain embodiments, the plurality of carbon nanotubes can include a multi-walled carbon nanotube or a single-walled carbon nanotube. The polymer can include polycarbonate, polyvinyl chloride, polyetherimide, poly(methyl methacrylate), polystyrene, or polyetheretherketone, or a mixture thereof. The solvent can be dichloromethane.

In certain embodiments, the plurality of carbon nanotubes can be uniformly dispersed in the polymer. The percentage of the plurality of carbon nanotubes in the polymer carbon nanotube composite can be less than 10% by weight. The percentage of the plurality of carbon nanotubes in the polymer carbon nanotube composite can be less than 2% by weight.

Other aspects, embodiments, and features will be apparent from the following description, the drawings, and the claims.

### BRIEF DESCRIPTION OF THE DRAWINGS

FIG. 1 shows the preparation process of (a) c-MWCNT-ODA and (b) n-MWCNT-ODA, and FIG. 1(c) shows a schematic of the process.

FIG. 2 shows dispersion results of c-MWCNT-ODA, n-MWCNT-ODA and pristine MWCNT-COOH (the samples were placed stably for one week after sonication for 30 min, the concentration was 0.2 wt %).

FIG. 3 shows IR spectrum of pristine MWCNT-COOH, ODA, c-MWCNT-ODA and n-MWCNT-ODA. The peaks at 2916 cm⁻¹ and 2847 cm⁻¹ in the c-MWCNT-ODA, 2913 cm⁻¹ and 2850 cm⁻¹ in the n-MWCNT-ODA are due to the C-H stretching vibration of the alkyl chain (υ(CH₂,CH₃)) while the similar peaks appearing at 2918 cm⁻¹ and 2845 cm⁻¹ for the pristine amine.

FIG. 4 shows XRD study of pristine MWCNT-COOH, c-MWCNT-ODA and n-MWCNT-ODA.

FIG. 5 shows the TGA weight loss curves of ODA, pristine MWCNT-COOH, c-MWCNT-ODA and n-MWCNT-ODA.

FIG. 6 shows SEM image of the nanocomposite film with 1.0 wt % c-MWCNT-ODA (a and b), and with 1.0 wt % n-MWCNT-ODA (c and d).

FIG. 7 shows (a) The TGA weight loss curves and (b) DSC curves of PEI and composites with different c-MWCNT-ODA concentrations.

FIG. 8 shows mechanical properties for PEI and its composites with different modified MWCNT concentrations: (a, b) show DMA results, and inset is the tans versus temperature; (c, d) show typical stress-strain curves.

FIG. 9 shows SEM image of the nanocomposite film with 2.0 wt % p-MWCNT-ODA. The polymer matrix can have partial aggregation of MWCNTs.

FIG. 10 shows typical stress-strain curves for neat PEI and its composites with ODA.

FIG. 11 shows SEM image of the nanocomposite film with 5.0 wt % c-MWCNT-ODA. MWCNTs network can be formed in polymer matrix.

FIG. 12 shows DC resistivity of PEI and the composites with c-MWCNT-ODA and n-MWCNT-ODA at room temperature.

FIG. 13 shows cryo-fractured FESEM image of the pure PC film in (a) and its composite film with 2.0 wt % n-MWCNT-ODA in (b); FIG. 13(c) is the image magnification of (b).

FIG. 14 shows DMA results of PC and PC nanocomposites with different concentrations of non-covalent MWCNTs: (a) storage modulus; (b) tans vs. temperature.

FIG. 15 shows strain-stress curves of PC and its nanocomposites.

FIG. 16 shows DSC curves of PC and its nanocomposites with different n-MWCNT-ODA concentrations.

FIG. 17 shows TGA curves of PC and its composites with different n-MWCNT-ODA concentrations.

FIG. 18 shows volume resistivity of PC and the composites with c-MWCNT-ODA and n-MWCNT-ODA at room temperature.

### DETAILED DESCRIPTION

A polymer composite can include a plurality of carbon nanotubes dispersed in a solid polymer matrix. The examples of the polymer that can be used to form the polymer composite include polycarbonate, polyvinyl chloride, polyetherimide, poly(methyl methacrylate), polystyrene, or polyetheretherketone, or a mixture thereof. The resistivity of the polymer composite can be between 1.0×10⁶ Ω·cm and 1.0×10³ Ω·cm. To form a polymer carbon nanotube composite, a plurality of carbon nanotubes can be dispersed in a polymer matrix.

The carbon nanotubes can be functionalized, which can be covalent functionalization or non-covalent functionalization.

Commercial multi-walled carbon nanotubes (MWCNTs) can be modified with a long alkyl chain molecule, octadecylamine (ODA), to produce a uniform dispersion in commercial PEI matrices. Both covalent and noncovalent modification of MWCNTs with ODA can be prepared and compared. Modified MWCNTs can be incorporated in PEI matrices to procedure nanocomposites membranes by a simple casting method. Mechanical properties, thermal stability and conductivity of the polyetherimide (PEI)/MWCNT composites show a unique combination of properties, such as high electrical conductivity, high mechanical properties, and high thermal stability at a low content of 1.0 wt % loading of ODA modified MWCNTs. This covalent functionalization can enhance the thermal and mechanical properties of PEI composites more than the noncovalent functionalization with minimal defects on MWCNTs surface. Moreover, electrical resistivity can decrease around 10 orders of magnitude with only 0.5 wt % of modified MWCNTs. The processing technique is easy and reproducible. It can be expanded to include other types of thermoplastics such as polycarbonate (PC), polyamide (PA), polyether sulfone (PES), polyaryletherketone (PAEK), and so on.

Polyetherimide (PEI), which is widely used as an engineering plastic in electronic industry, aerospace, and auto industry due to its high thermal stability, flexibility, good mechanical and radiation resistance. Some drawbacks include extremely low conductivity, atmospheric moisture absorption, and poor fluidity at high temperature which highly limited its application. Many efforts to improve its properties by adding carbon nanotubes (CNT) or graphitic nanoplatelets (GNP) into the matrix, or compositing with other special structure material such as liquid crystalline polymer (LCP) or carbon nanofibers (CNF) have been made. See, for example, Liu T X, et al., Compos. Sci. Technol. 2007, 67(3-4):406-412; Kumar S, et al., Nanotechnology 2009, 20(46):1-9; Goh P S, et al., Solid State Sci. 2010, 12(12):2155-2162; Kumar S, et al., Nanotechnology 2010, 21(10):1-8; Carfagna C, et al., J. Appl. Polym. Sci. 1991, 43(5):839-844; Nayak G C, et al., Compos. Part. A-appl. S 2010, 41(11):1662-1667; Kumar S, et al., Mat. Sci. Eng. B-Solid. 2007, 141(1-2):61-70; Li B, et al., Polym. Eng. Sci. 2010, 50(10):1914-1922, each of which is incorporated by reference in its entirety.

Carbon nanotubes have drawn lots of attentions as “materials of the 21st century” due to their impressive physical and chemical properties since their serendipitous discovery in 1991. See, for example, Iijima S, Nature 1991, 354(6348):56-58, which is incorporated by reference in its entirety. Their excellent electronic, mechanical, and thermal properties make them a great candidate as a filler for the reinforcement of commercial plastic. See, for example, Coleman J N, et al., Adv. Mater. 2006, 18(6):689-706; Coleman J N, et al., Carbon 2006, 44(9):1624-1652; Moniruzzaman M, et al., Macromolecules. 2006, 39(16):5194-5205; Diez-Pascual A M, et al., J. Mater. Chem. 2010, 20(38):8247-8256; Xia H S, et al., Soft Matter 2005, 1(5):386-394; Spitalsky Z, et al., Prog. Polym. Sci. 2010, 35(3):357-401; Gruner G., J. Mater. Chem. 2006, 16(35):3533-3539, each of which is incorporated by reference in its entirety.

Compared to single-walled carbon nanotubes (SWCNTs), multi-walled carbon nanotubes MWCNTs are cheaper, and are used more widely in application of polymer/CNT composites. The high performance PEI/MWCNT composite can be considered as a multi-functional material in the next generation of aircraft or other applications where saving weight and multi-functionality are required. However, the dispersion of CNT in common solvents is usually poor because of the strong tendency to aggregate due to the large surface/volume ratio and strong van der waals forces. See, for example, Chakraborty A K, et al., J. Nanosci. Nanotechnol. 2008, 8(8):4013-4016, which is incorporated by reference in its entirety. Thus, the homogeneous dispersion of CNT in the plastic matrix is one of the most critical factors for successful composite applications.

Efforts have been invested in developing stable and well dispersed CNTs in organic solvents. Two major methods have been reported: covalent and noncovalent functionalization. See, for example, Bellayer S, et al., Adv. Funct. Mater. 2005, 15(6):910-916; Price B K, et al., J. Am. Chem. Soc. 2006, 128(39):12899-12904; Hu H, et al., J. Am. Chem. Soc. 2003, 125(48):14893-14900; Coleman K S, et al., J. Am. Chem. Soc. 2003, 125(29):8722-8723; Ge J J, et al., J. Am. Chem. Soc. 2005; 127(28):9984-9985; Blake R, et al., J. Mater. Chem. 2006, 16(43):4206-4213; Krstic V, et al., Chem. Mater. 1998,10(9):2338-2345; Star A, et al., Angew. Chem. Int. Edit. 2001, 40(9):1721-1725; Coleman J, et al., Adv. Mater. 2000, 12(6):401-401; Li L Y, et al., J. Am. Chem. Soc. 2006, 128(5):1692-1699; Suri A, et al., Chem. Mater. 2008, 20(5):1705-1709; Zhang L, et al., Polymer 2009, 50(15):3835-3840; Vaisman L, et al., Adv. Colloid Interfac 2006, 128:37-46, each of which is incorporated by reference in its entirety. Compared to the covalent functionalization, the main advantage of the noncovalent functionalization is that the chemical groups can be introduced to the CNT surface without disrupting the intrinsic structure and electronic network. See, for example, Karousis N, et al., Chem. Rev. 2010, 110(9):5366-5397, which is incorporated by reference in its entirety. The advantage of covalent functionalization is that functional groups can be covalently linked to the surface of CNT and the linkage is mechanically stable and permanent at the cost of breaking of the sp² conformation of the carbon atom. Therefore, CNT modified with covalent method is usually more stable and more easily controlled. There have been several covalent methods reported to achieve high performance PEI/MWCNT composite. MWCNT modified with grafting PEI can be used to get MWCNT/PEI composites, where the MWCNTs were found to disperse well in polymer matrix. The tensile strength and modulus of PEI composite grafted with MWCNT increased dramatically with the MWCNTs' concentration. Other methods including ultrasound and melting blend were involved in improving the dispersion of MWCNT in polymer matrix. See, for example, Siochi E J, et al., Compos. Part. B-eng. 2004, 35(5):439-446, which is incorporated by reference in its entirety. A solvent free, with no surface modification needed and new ultrasound assisted twin screw extrusion method for manufacturing PEI/MWNT nanocomposites was developed. See, for example, Isayev A I, et al., Polymer 2009, 50(1):250-260, which is incorporated by reference in its entirety. The mechanical properties data shows that MWCNT loading and ultrasound have a positive effect on the tensile strength and Young's modulus of the nanocomposites.

Long-chain molecules, octadecylamine (ODA), can be used first to help in dissolving single-walled carbon nanotubes (SWCNTs) in solvent. See, for example, Chen J, et al., Science 1998, 282(5386):95-98, which is incorporated by reference in its entirety. Due to the strong interaction of ODA with CNT via formation of amides and the breakdown of CNT bundles, SWCNTs grafted with ODA can be well dispersed in organic solvent. See, for example, Hamon M A, et al., Adv. Mater. 1999, 11(10):834-837, which is incorporated by reference in its entirety. Not only SWCNTs with covalent functionalization, but also with non-covalent functionalization can be dispersed well in solvents. See, for example, Chen J, et al., J. Phys. Chem. B 2001,105(13):2525-2528, which is incorporated by reference in its entirety. Homogeneous nanotube-based copolymers and polymer composites can be prepared. Xu et al. found that ODA chains grafted with multi-walled carbon nanotubes (MWCNTs) were partially crystalized, and they thought that ODA preferred to react at the tube-ends and the defects on the sidewall of MWCNTs. See, for example, Xu M, et al., Chem. Phys. Lett. 2003, 375(5-6):598-604, which is incorporated by reference in its entirety. Though ODA can be used to improve the solubility or dispersability of CNT, the application of CNT modified with ODA in plastic nanocomposites is rarely reported. Salavagione et al. used MWCNT grafted with a long chain molecule 1-octadecylalcohol to improve the solubility of MWCNT in poly(vinyl chloride) (PVC) matrix. See, for example, Salavagione H J, et al., J. Mater. Chem. 2012, 22(14):7020-7027, which is incorporated by reference in its entirety. No indications were presented whether this effect can be used in other commercial polymeric systems.

In one method, Octadecylamine (ODA) can be utilized to functionalize commercial MWCNT-COOH by both covalent and noncovalent methods. The mechanical properties, thermal stability and conductivity of the polyetherimide (PEI)/MWCNT composites can be investigated and compared based on these two kinds of functionalized MWCNTs.

Well dispersed multi-walled carbon nanotubes (MWCNT) in DCM can be prepared by covalent and noncovalent functionalization with octadecylamine (ODA). Then the modified MWCNTs suspensions can be mixed with PEI solutions by stirring and sonication, and a simple MWCNT composite film can be obtained by coating. A unique combination of properties, such as high electrical conductivity, high mechanical properties, and high thermal stability at low loading of MWCNTs, both covalent and non-covalent functionalization, can be obtained. Individual MWCNTs can be dispersed in the PEI matrix which has a strong interfacial bonding with PEI matrix. The presence of MWCNT can increase the thermal stability and mechanical property by a significant amount at only 1.0 wt % MWCNT loading, which is the best value for the nanocomposites. Excess ODA can give a strong negative effect on the property of PEI matrix. Therefore, the thermal and mechanical properties will not improve further by only increasing modified MWCNTs content. The electrical conductivity can be enforced by adding these two different MWCNTs, and the values increased dramatically by increasing MWCNTs contents. MWCNTs with covalent functionalization can be better than that with non-covalent functionalization to improve the thermal and mechanical properties of a polymer, such as PEI.

### EXAMPLE

### Materials

Polyetherimide (PEI) in fine powder was supplied by SABIC Innovative Plastics under the trade name of Grade ULTEM 1000P. Carboxyl group functionalized MWCNTs (MWCNT-COOH, diameter is 15±5 nm, length is 1-5 μm and purity >95%) were purchased from Nanolab Inc. Octadecylamine (ODA) was purchased from Sigma and used as received. The organic solvents, chloroform, oxalyl chloride, N′N-dimethylformamide (DMF), tetrahydrofuran (THF), dichloromethane (DCM) and methanol were all purchased from Sigma-Aldrich and used without further purification.

Covalent Functionalization of ODA on MWCNT-COOH (c-MWCNT-ODA)

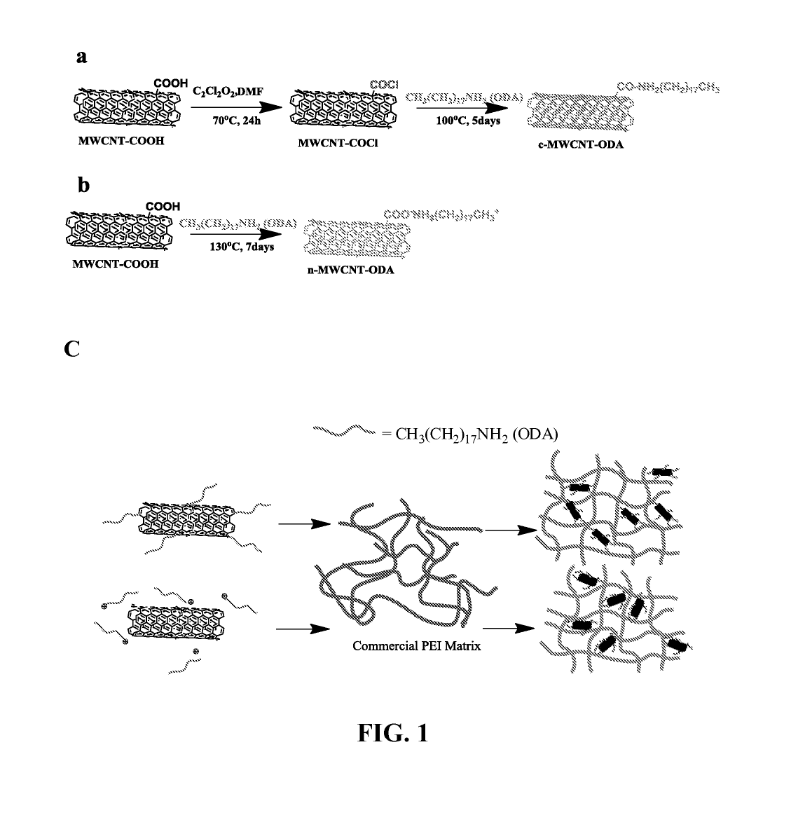

A sample of c-MWCNT-ODA was prepared as shown in FIG. 1a. A mixture of 300 mg MWCNT, 40 mL oxalyl chloride and 3 drop of DMF was stirred at 70° C. for 24 hours, and then it was centrifuged at 4000 rpm for 5 min followed by cooling down. The extra oxalyl chloride was decanted and the remaining solid was washed with THF, and the supernatant was decanted after centrifugation. After repeating this step with THF for four times, the remaining solid was dried at 60° C. in an oven overnight. The product, MWCNT-COCl, was obtained and further treated with mixing with ODA (6 g) at 100° C. for 5 days. After cooling down, the solid was washed with a mixture of dichloromethane (DCM) and methanol (1:1). The supernatant was decanted after centrifugation. After repeating this step with the mixture solvent for four times, the c-MWCNT-ODA was obtained after drying the remaining solid at 60° C. in an oven for 24 hours.

Non-Covalent Functionalization of ODA on MWCNT-COOH (n-MWCNT-ODA)

A sample of n-MWCNT-ODA was prepared as shown in FIG. 1b. A mixture of 500 mg MWCNT and 6 g ODA was heated at 130° C. for 7 days. After cooling to room temperature, the black solid was washed with dichloromethane (DCM) and methanol (1:1). After centrifugation, the supernatant was decanted. After repeating this step for four times, the n-MWCNT-ODA was obtained by drying solid at 60° C. in an oven for 24 hours.

### Preparation of Composite Film

PEI (2 g) was completely dissolved into DCM (10 ml) and stirred for 2 h. The functionalized MWCNT of c-MWNT-ODA or n-MWCNT-ODA were dispersed separately into DCM under bath-type sonication for 1 h to form homogeneous suspension, and then it was mixed with the PEI solution. The mixture was stirred first for 1 h at room temperature, and then treated under bath-type sonication for 1 h. The obtained solutions were coated on a clean glass plate followed by solvent evaporation at room temperature for 24 h. The samples with about 0.3 mm thickness were dried at 80° C. for 24 h to remove any remaining solvent. A series of c-MWNT-ODA/PEI or n-MWNT-ODA/PEI nanocomposites with functionalized MWCNT concentration of 0 wt %, 0.1 wt %, 0.5 wt %, 1.0 wt %, 2.0 wt % and 5.0 wt % in PEI solid contents were obtained following this procedure.

### Characterization for the Functionalized MWCNT

Fourier transform infrared spectroscopy (FTIR) spectra of the c-MWCNT-ODA and n-MWCNT-ODA were recorded between 500 cm⁻¹ and 4000 cm⁻¹ by a Thermo Nicolet iS10. The X-ray powder diffraction (XRD) patters were performed on the c-MWCNT-ODA and n-MWCNT-ODA samples by a Bruker D8 Advance (40 KV, 40 mA) with Cu Kα(λ=1.5406 Å) irradiation at a scanning rate of 2°/min in the 2θ range of 10-40°. The decomposition behavior test was done through the thermogravimetric analysis (TGA) using Netzsch TG 209 F1 Iris at a temperature range of 30-600° C. under N₂ flow with a heating rate of 10° C./min.

### Characterization of the Composite Films

The morphological study of the composite was conducted on FEI Magellan FEGSEM (USA) scanning electron microscope (SEM). The cryo-fractured surfaces were coated with a thin layer of gold (5 nm). The vacuum was on the order of 10⁻⁴-10 ⁶ mmHg during scanning of the composite samples. Dynamic mechanical thermal analysis (DMA) was performed on DMA 242C (Netzsch, Germany) in the thin tension mode, at a constant frequency of 1 Hz, with the static force at 0.3N, the dynamic force at 0.2N, a heating rate of 2 K/min under a nitrogen atmosphere and in the temperature range of 50 to 230° C. Tensile testing was done on a commercial universal testing machine (Changchun Zhineng Company, China) at room temperature with a crosshead speed of 5 mm/min. Specimens were cut from the casted films with 50 mm gauge lengths and 10 mm widths. The decomposition behavior of the composites was studied using thermogravimetric analysis (TGA) on a TG 209 F1 Iris (Netzsch, Germany) thermogravimetric analyzer in a nitrogen atmosphere from 30 to 600° C., with a heating rate of 10° C./min. The thermal behavior of the nanocomposites was studied using a differential scanning calorimeter (DSC 204 F1 Phoenix, Netzsch, Germany). The heating rate was 10° C./min under a nitrogen atmosphere with a flow rate of 20 ml/min.

The electrical conductivities of the samples were measured as follows: specimens were cut from the edge of each PEI nanocomposite film toward the center with 30 mm lengths, 10 mm widths, and about 0.3-0.5 mm thickness. A constant voltage of 100 V DC was applied across the specimen using a Keithley model 248 high voltage supply (USA). And the current was monitored with a Keithley 6517B (USA) electrometer. The results were obtained by averaging the conductivities from three different specimens of each nanocomposite film.

### Dispersion Behavior of Functionalized MWCNT in DCM

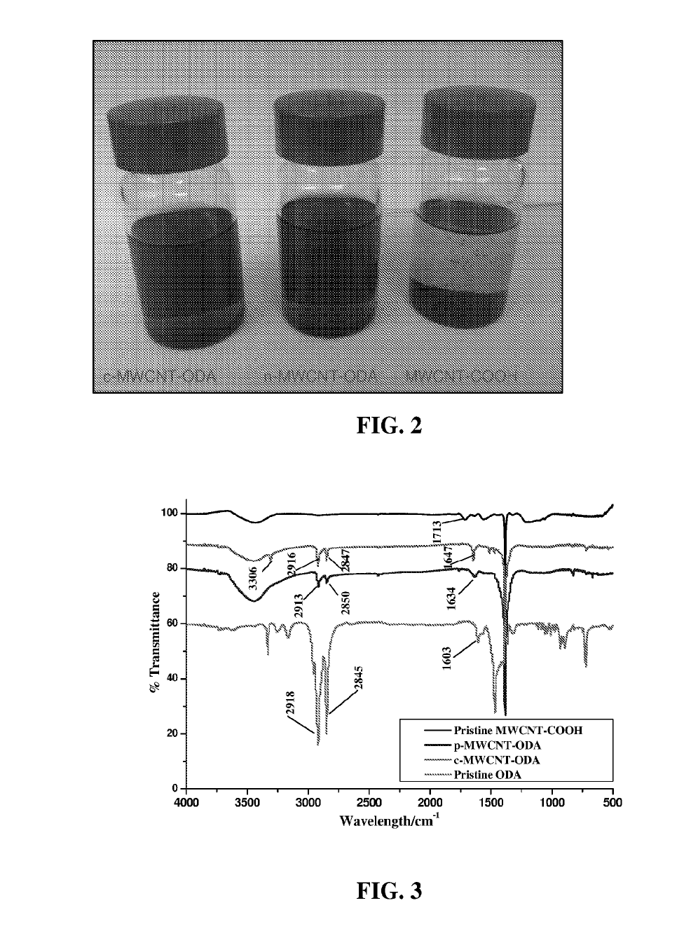

The dispersion behaviors of the c-MWCNT-ODA, n-MWCNT-ODA and the pristine MWCNT-COOH samples in DCM are showed in FIG. 2 (the concentration of nanoparticles in DCM was 0.2 wt %). Based on the visual characteristic of the dispersion, sedimentation can be obviously observed for the pristine MWCNT-COOH because of the strong van der Waals interaction between the sidewalls of the MWCNT, while for the c-MWCNT-ODA and the n-MWCNT-ODA, no precipitate of black agglomeration was observed. The good dispersion of functionalized MWCNTs in DCM supports the preparation of homogenous mixture of MWCNTs and PEI.

### The Confirmation of ODA Modified MWCNTs

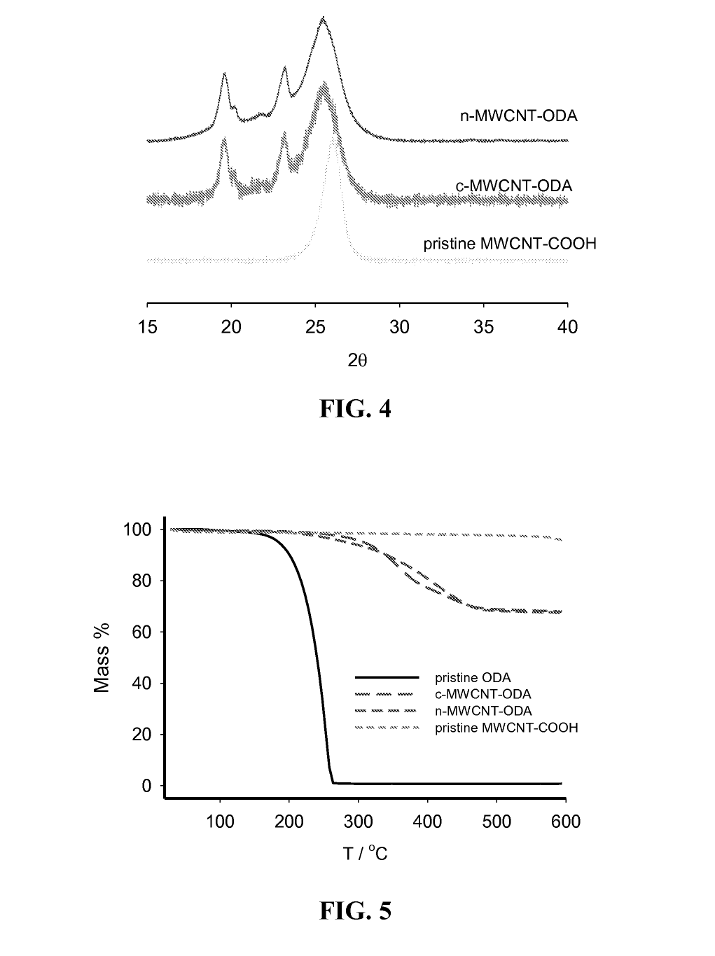

FTIR, XRD and TGA were used to confirm the functionalization of MWCNTs with ODA. The FTIR peak of FIG. 3 at 1647 cm⁻¹ in the c-MWCNT-ODA is due to the stretching vibration of the amide carbonyl group (υ(C═O)), indicating the formation of the carboxylate group, which is a strong evidence for the successful covalent functionalization of MWCNT with ODA. The peak at 3306 cm⁻¹ in the c-MWCNT-ODA comes from the ODA structure (3300 cm⁻¹ in pristine ODA) which supports that ODA is grafted to the surface of carbon nanotubes. For the n-MWCNT-ODA, the peak at 1634 cm⁻¹ is due to the N—H bend of the amide (1603 cm⁻¹ for the pristine ODA), the obvious shift could be caused by the strong interaction between ODA molecule and pristine MWCNTs, which indicate the non-covalent functionalized of ODA with carbon nanotubes. The slight shift of XRD peak at 2θ=25.8° further support the functionalization of ODA to MWCNTs (FIG. 4). The new diffraction peaks at 2θ=23.2°, 19.6° appeared in modified MWCNTs belonged to crystalline ODA, indicating that ODA was combined to the pristine MWCNTs by both covalent and non-covalent method.

ODA has a low decomposition temperature at near 160° C. (FIG. 5), which means that ODA has poor thermal stability compared with MWCNT-COOH which is still stable at high temperature. As shown in FIG. 5, compared with pristine MWCNT-COOH, the thermal properties of both functionalized MWCNTs are decreased, and c-MWCNT-ODA has a better thermal stability than n-MWCNT-ODA, which indicates that the covalent (chemical) interaction between the MWCNT-COOH and ODA is much stronger than the non-covalent (physical) interaction between them. The loss in weight of functionalized MWCNT is mainly caused by the decomposition of ODA group. The breakage energy of chemical bond is higher than physical, so the start decomposition temperature of c-MWCNT-ODA (about280° C.) is higher than n-MWCNT-ODA (about 230° C.). In addition, a residue weight of 67 wt % is found in both two functionalized MWCNTs, which indirectly indicates that the ratio of ODA to MWCNT in functionalized MWCNT is 1:2. And this ratio is good for MWCNT-ODA becoming soluble in organic solvent.

### SEM Study on MWCNT-ODA Dispersed in the Composite Film

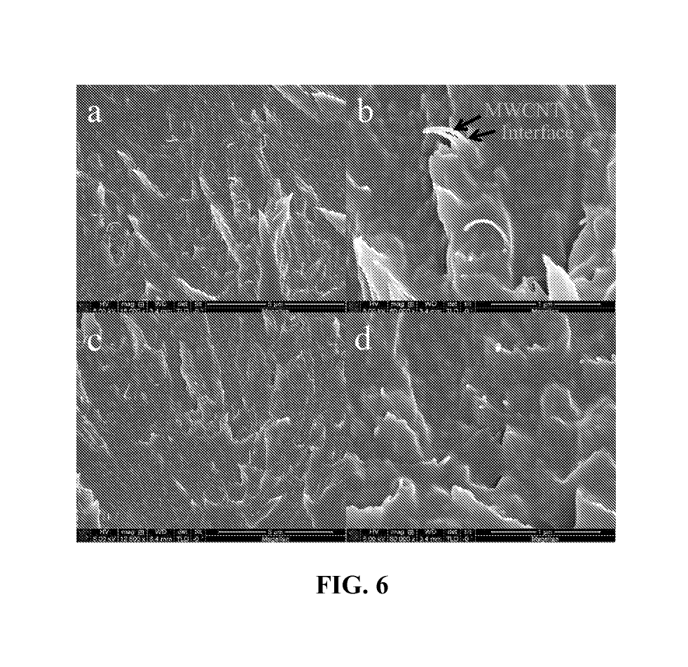

Scanning electron microscope (SEM) was employed to study the morphology of the fracture surface for the PEI composite film containing 1 wt % of c-MWCNT-ODA or n-MWCNT-ODA. No remarkable physical damages or shortening of MWCNTs are observed, which indicated that ODA modification, both covalent and non-covalent is a mild method that conserves the morphology structure of the nanotubes. An abundant of fine and homogeneously dispersed c-MWCNT-ODA (FIG. 6a, 6b) and n-MWCNT-ODA (FIG. 6c, 6d) at individual level throughout the PEI matrix, no obvious MWCNTs aggregation occurred. In c-MWCNT-ODA, the strong adhesion between the c-MWCNT-ODA and the matrix means a good wettability between them (FIG. 6a). Individual c-MWCNT-ODA can be easily found (FIG. 6b) shows that the wrapping of c-MWCNT-ODA by long alkyl chain of ODA can reduce the van der waals forces between the MWCNTs efficiently resulting in the well dispersion of MWCNT in the PEI matrix. This is the critical issue for the mechanical properties of the composite because it will contribute to achieving efficient transfer from load to the MWCNT network in the PEI matrix. The well dispersion of MWCNT also help in distributing the stress uniformly and minimize the presence of stress concentrations. As observed from FIG. 6, the diameter of functionalized MWCNT-COOH in matrix was much thicker than the pristine MWCNT-COOH (15±5 nm), and the carbon nanotube was immersed into polymer matrix (as shown in FIG. 6b), which meant that MWCNT-COOH were wrapped by PEI when it dispersed into polymer matrix.

### Thermal Properties of the Composite Film

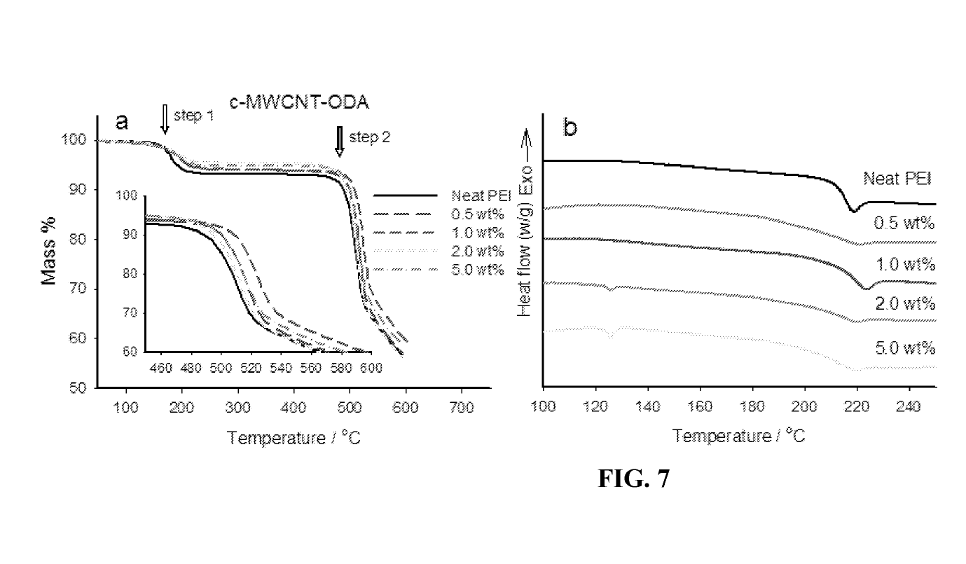

The thermal behavior of neat PEI membranes and PEI composites membranes with the different MWCNT concentration were studied by TGA and DSC analysis, and the results were summarized in table 1. Two steps were observed in N₂ atmosphere thermal degradation of all samples, as shown in FIG. 7a. The first step between 160° C. and 210° C. could be caused by the presence of labile methyl group present in PEI structure or the decomposition of ODA. The second step is the main decomposition of PEI matrix, due to the cleavage of phenyl-phthalimide bonds. As shown in FIG. 7, the decomposition temperature was increased with increasing c-MWCNT-ODA concentration, and it reached the maximum value at 1.0 wt %, where it started to decrease with further increase of c-MWCNT-ODA concentration, due to the effect of ODA.

TABLE 1
Thermal properties of PEI and its composites.

| | | Temp. at | Temp. at | Temp. at | | |
|---|---|---|---|---|---|---|
| | | 10 wt % | 30 wt % | 40 wt % | | |
| | | weight | weight | weight | T_{g} by | T_{g} by |
| | | loss | loss | loss | DSC | DMA |
| | | (° C.) | (° C.) | (° C.) | (° C.) | (° C.) |
| c-MWCNT- | 0 | 488 | 519 | 563 | 216.9 | 218.2 |
| ODA wt % | 0.5 | 497 | 525 | 570 | 219.2 | 220.4 |
| | 1.0 | 506 | 536 | 597 | 224.4 | 225.6 |
| | 2.0 | 494 | 520 | 564 | 217.0 | 218.5 |
| | 5.0 | 498 | 528 | 583 | 221.8 | 222.3 |
| n-MWCNT- | 0 | 488 | 519 | 563 | 216.9 | 218.2 |
| ODA wt % | 0.5 | 492 | 520 | 569 | 217.4 | 219.1 |
| | 1.0 | 498 | 529 | 592 | 221.6 | 223.9 |
| | 2.0 | 494 | 519 | 558 | 217.1 | 218.4 |
| | 5.0 | 496 | 523 | 574 | 219.1 | 220.5 |

The thermal stability could be improved by adding carbon nanotubes, because of its excellent thermal stability, and this can slow down the materials' volatilization or decomposition. Meanwhile, the well dispersion of MWCNT in the polymer matrix restricted the segmental motion of polymer chain, which is attributed to the increase of decomposition temperature. However, the thermal stability of ODA is poor, and the existence of ODA in polymer matrix affects the thermal stability of composite. The content of ODA will be increased with increasing n-MWCNT-ODA or c-MWCNT-ODA concentration, and the influence on composite thermal stability is observed.

As shown in FIG. 7b and table 1, it can be concluded, compared with neat PEI (T_{g}=216.9° C.), that T_{g} is increased by about 8° C. after incorporating 1.0 wt % c-MWCNT-ODA, and 5° C. after incorporating 1.0 wt % n-MWCNT-ODA into PEI matrix. This also indicates the mobility of polymer chains is reduced due to the constraint effect of MWCNTs, and the interaction of MWCNT with PEI is obvious in the covalent functionalization more than non-covalent functionalization. As well as the effect on the thermal stability of ODA to PEI matrix, the over increasing content of ODA will decrease the T_{g} of nanocomposites. In addition, there is another smaller peak in DSC curves of 2.0 wt % and 5.0 wt %, which may belong to the diffusion or melt of ODA chain. Because ODA prefers to react at the tube-ends or the defects on the sidewall of MWCNT, where the active areas are, this can induce the ODA chains to aggregate or form crystals on the surface of MWCNTs. The diffusion of the aggregated ODA chain or the melt of the crystalized ODA will lead to an obvious change of enthalpy. And this peak is not obvious when the content of ODA is low, even does not exist in curves of 0.5 wt % and 1.0 wt % functionalized MWCNTs.

### Mechanical Properties of the Composite Films

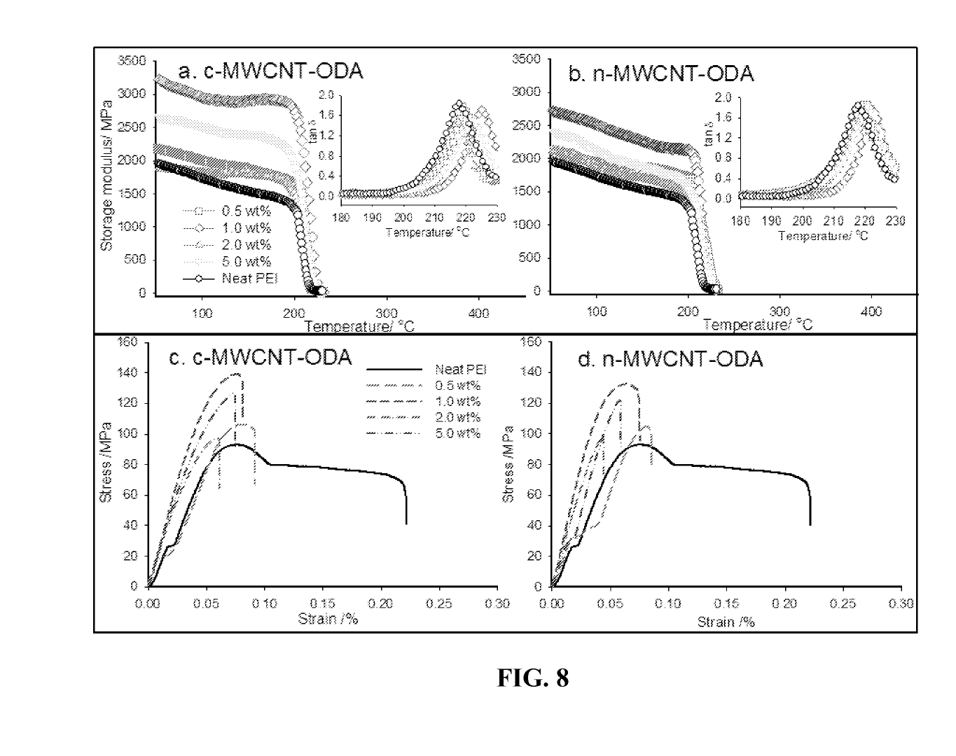

DMA is a very important tool for studying relaxation in polymers and in determining the performance of material under stress and temperature. FIGS. 8a and 8b show the DMA curves as a function temperature for PEI and its nanocomposites. As shown in FIG. 8a, the storage modulus (E′) for the PEI composites with the c-MWCNT-ODA are higher than that of pure PEI, and the storage modulus increased significantly with increasing c-MWCNT-ODA concentration from 0 to 1.0 wt %, and at the concentration of 2.0 wt %, it decreases, but with further increasing c-MWCNT-ODA, 5.0 wt % in FIG. 8a, the modulus increases again. The results are summarized in Table 2. The storage modulus at 50° C. is 3.31 GPa for the composite containing 1.0 wt % c-MWCNT-ODA, which exhibits about 70% increment compared with neat PEI of 1.95 GPa. The significant improvement in storage modulus of PEI nanocomposites is ascribed to the combined effect of high performance and fine dispersion of high aspect ratio MWCNT filler. And this is coincident with thermal properties of PEI composites. However, the existence of crystalline ODA takes a negative effect on the modulus of PEI matrix, and with the increasing of ODA proportion in matrix, the mechanical property of PEI composite will be weakened, which induces the storage modulus of composites with 2.0% and 5.0 wt % c-MWCNT-ODA is lower than that of pure PEI. The similar trend is observed in FIG. 8b of PEI with n-MWCNT-ODA.

TABLE 2
Mechanical properties of neat PEI and its composites.

| | | Storage | Storage | | | Elon- |
|---|---|---|---|---|---|---|
| | | modulus | modulus | Tensile | Tensile | gation |
| | | at 50° C. | at 200° C. | strength | modulus | at break |
| | | (GPa) | (GPa) | (MPa) | (GPa) | (%) |
| c-MWCNT- | 0 | 1.95 | 1.27 | 78.6 | 1.67 | 22 |
| ODA wt % | 0.5 | 2.19 | 1.63 | 103 | 2.15 | 9.2 |
| | 1.0 | 3.31 | 2.77 | 137 | 2.78 | 8.1 |
| | 2.0 | 1.92 | 1.51 | 96.9 | 2.07 | 6.2 |
| | 5.0 | 2.68 | 1.90 | 126 | 2.46 | 7.2 |
| n-MWCNT- | 0 | 1.95 | 1.27 | 78.6 | 1.67 | 22 |
| ODA wt % | 0.5 | 2.12 | 1.60 | 101 | 2.02 | 8.5 |
| | 1.0 | 2.72 | 2.14 | 128 | 2.55 | 7.4 |
| | 2.0 | 2.13 | 1.46 | 99.7 | 1.96 | 4.7 |
| | 5.0 | 2.40 | 1.54 | 120 | 2.49 | 5.9 |
| ODA wt % | 0.5 | — | — | 80.5 | 1.64 | 10.7 |
| | 1.0 | — | — | 75.0 | 1.51 | 8.5 |
| | 5.0 | — | — | 66.4 | 1.40 | 6.5 |

From Table 2, with the same MWCNT concentration, the storage modulus of PEI/c-MWCNT-ODA is much larger than that of PEI/n-MWCNT-ODA, which indicates that the mechanical property of PEI composited MWCNT with covalent modification is much stronger than with non-covalent modification. On one hand, due to the homogenous dispersion of MWCNTs in PEI matrix, the high performance of the nanocomposites is obtained. On the other hand, due to the strong interfacial interaction between MWCNTs and PEI, MWCNT can be wrapped by PEI, and the strong adhesion of MWCNT with PEI make PEI chain stiffer and more rigid. Compared with pristine MWCNT, the c-MWCNT-ODA is like a brush, and the grafted ODA is the whisker. The existence of the whiskers makes the adhesion of c-MWCNT-ODA with PEI easier, and the PEI chain can be caught tightly by c-MWCNT-ODA. While the interaction of ODA and MWCNT in p-MWCNT-ODA is weaker than c-MWCNT-ODA, and the electrostatic fore between ODA and MWCNT is weakened when ODA molecules interacts with PEI chain, resulting in the MWCNTs cannot adhere to PEI chain tightly. Herein, PEI chain with c-MWCNT-ODA modification is stiffer and stronger than with p-MWCNT-ODA modification, which leading to a higher storage modulus.

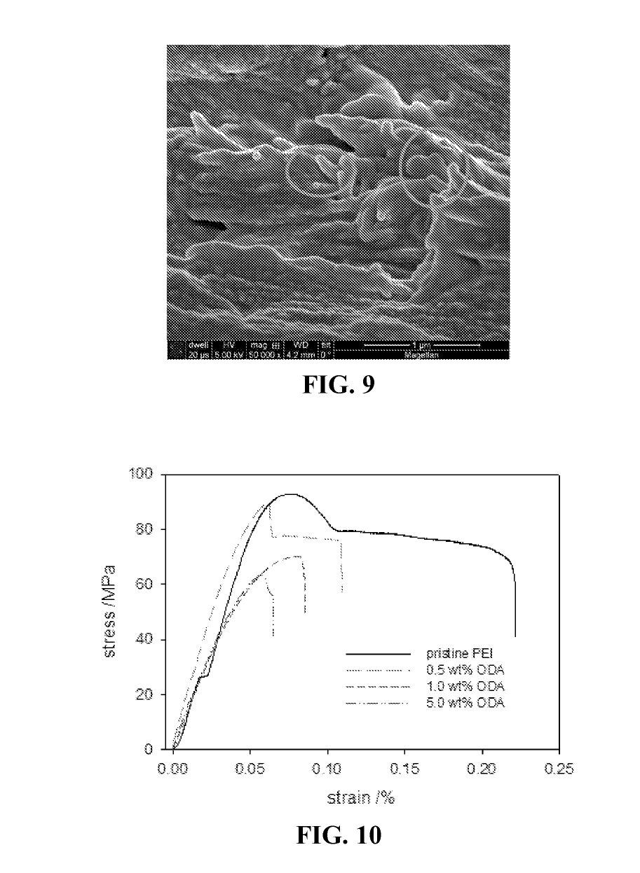

Typical stress-strain curves for neat PEI and its nanocomposites with different c-MWCNT-ODA concentration and c-MWCNT-ODA are shown in FIG. 8. All of the results are summarized in Table 2. For c-MWCNT-ODA as an example, as shown in FIG. 8c, it can be seen that the tensile properties of the nanocomposites with 1.0 wt % c-MWCNT-ODA is the best, the trend of the tensile properties with increasing c-MWCNT-ODA is in agreement with DMA results. The tensile strength of PEI is improved by about 74% from 78.6 MPa to 137 MPa; and the tensile modulus is improved by about 66% from 1.67 GPa to 2.78 GPa. A pronounced yield and post-yield drop are observed for neat PEI while there is no noticeable yield for c-MWCNT-ODA-reinforced PEI nanocomposites. Similar results are observed in nanocomposites with n-MWCNT-ODA-reinforced, as shown in FIG. 8d. Therefore, with adding a small amount of the functionalized MWCNT, the nanocomposite films become stronger due to the strong interfacial interactions between the nanotubes and PEI matrix. However, the properties of nanocomposites are not always increasing with increasing the ODA functionalized MWCNT concentration. One possible reason is the agglomeration of MWCNTs would be occurred in partial with increasing MWCNT concentration (FIG. 9). Another reason is caused by the existence of ODA molecule.

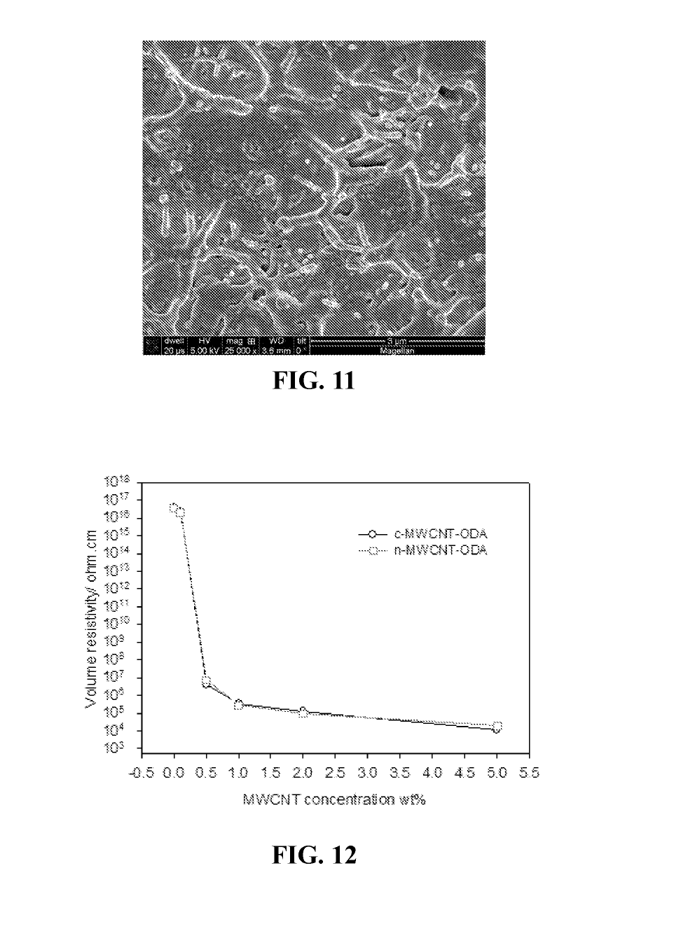

In order to reveal the influence of ODA on the properties of nanocomposites, the tensile properties of PEI only composited with loading different ODA concentration are invested. As shown in Table 2, the properties of composites are affected by increasing more ODA content. When the ODA content is low, less than 0.5 wt %, where tensile properties change a little, within the fluctuation range of 5% (FIG. 10); while further increasing the loading of ODA, the tensile strength will decrease, and when it reaches 5.0 wt %, the tensile strength is reduced by 16%, and the tensile modulus is reduced by 11%. As to nanocomposites, when the loading of ODA functionalized MWCNT is less than 1.0 wt % (the concentration of ODA in matrix is less than 0.5 wt %), the influence of ODA on the properties is negligible, and the well dispersion of MWCNT in PEI matrix displayed an effectiveness of the functionalized carbon nanotubes as a reinforcement agents, so the thermal properties and mechanical properties are enforced strongly with adding functionalized MWCNT; while the loading of ODA functionalized MWCNT is excess of 1.0 wt %, for example 2.0 wt % MWCNT-ODA (the loading of ODA is about 0.7 wt %), it will have a contrary result. However, as a result of the increase of network formation for MWCNTs (FIG. 11), the thermal and mechanical properties are improved again with further increasing c-MWCNT-ODA or n-MWCNT-ODA content.

### Electrical Properties of the Composite Films

Carbon nanotube is one of the best nanofillers to improve the conductivity of materials. The room temperature volume resistivity of PEI and PEI/MWCNT composites with various concentrations of n-MWCNT-ODA and c-MWCNT-ODA are shown in FIG. 12. The electrical resistivity decreases generally with increasing the content of functionalized MWCNT. It decreases slightly when the MWCNT content was at 0.1 wt %, from 3.82×10¹⁶ Ω·cm to 2.06×10¹⁶ Ω·cm for c-MWCNT-ODA/PEI composite, and to 2.17×10¹⁶ Ω·cm for n-MWCNT-ODA/PEI composite, respectively. At the small amount of MWCNT loading, the MWCNT could disperse separately in PEI matrix, the channel for transforming electrons could not be formed in a large area, which induces the little change of conductivity, and at this point, the composite is still insulator. However, the volume resistivity sharply decreased from 2.17×10¹⁶ Ω·cm at 0.1 wt % loading of c-MWCNT-ODA to 3.9×10⁶ Ω·cm at 0.5 wt % loading of c-MWCNT-ODA. The volume resistivity decreases dramatically about 10 power orders of the 0.5 wt % MWCNTs. The resistivity further decreased obviously with increasing the loading of c-MWCNT-ODA, and can fall down to 1.17×10⁴ Ω·cm at 5.0 wt % loading of c-MWCNT-ODA. The same trend was observed by adding n-MWCNT-ODA.

According to percolation theory, the percolation threshold of the nanocomposites can be between 0.1 wt %-0.5 wt %, which means with the increasing loading of MWCNT, a network forms which provides channels for the electrons transferring through the whole matrix. See, for example, Ounaies Z, et al., Compos. Sci. Technol. 2003; 63(11):1637-1646, which is incorporated by reference in its entirety. The volume resistivity decreases dramatically about 10 power orders of the 5.0 wt % MWCNTs which means that the conductivity property of PEI can be improved observably by using these functionalized MWCNT, and the chemical functionalization is stronger than physical functionalization (The volume resistivity of 5.0 wt % n-MWCNT-ODA/PEI composite is 1.91×10⁴ Ω·cm). The volume resistivity can fall down to 10³ Ω·cm. The obtained resistivity is one of the lowest values for MWCNT/polyimide composites films with the same MWCNT loading. Recently, Tang et al. reported a percolation threshold of surfactant-assisted polyimide/MWCNTs nanocomposites is in range 0.5˜1.0 wt % MWCNTs (from 3.08×10⁹ to 2.98×10⁶ Ω·cm), and the resistivity can be reduced to 8.02×10⁴ Ω·cm with loading 3.0 wt % MWCNT. See, for example, Tang Q Y, et al., Polym. Int. 2010; 59(9):1240-1245, which is incorporated by reference in its entirety. The conductivity of PEI could be improved by using MWCNT via a facile solution processing method, and the volume resistivity could be decreased to 10⁵ Ω·cm of loading 5.0 wt % MWCNT, which is yet much higher than the value obtained in this experiment.

PC and Its Composites with Functionalized MWCNTs

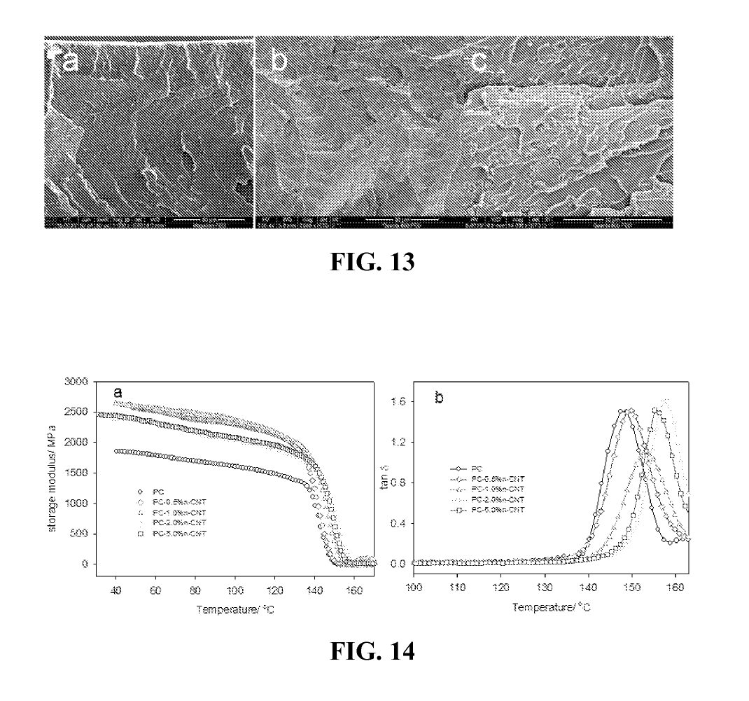

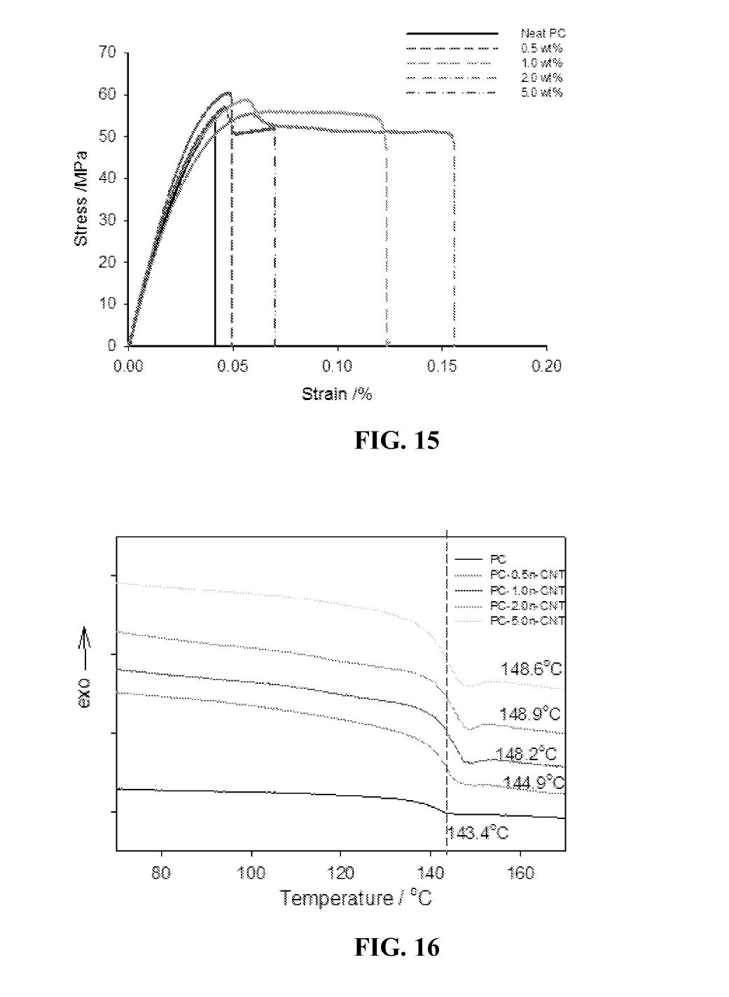

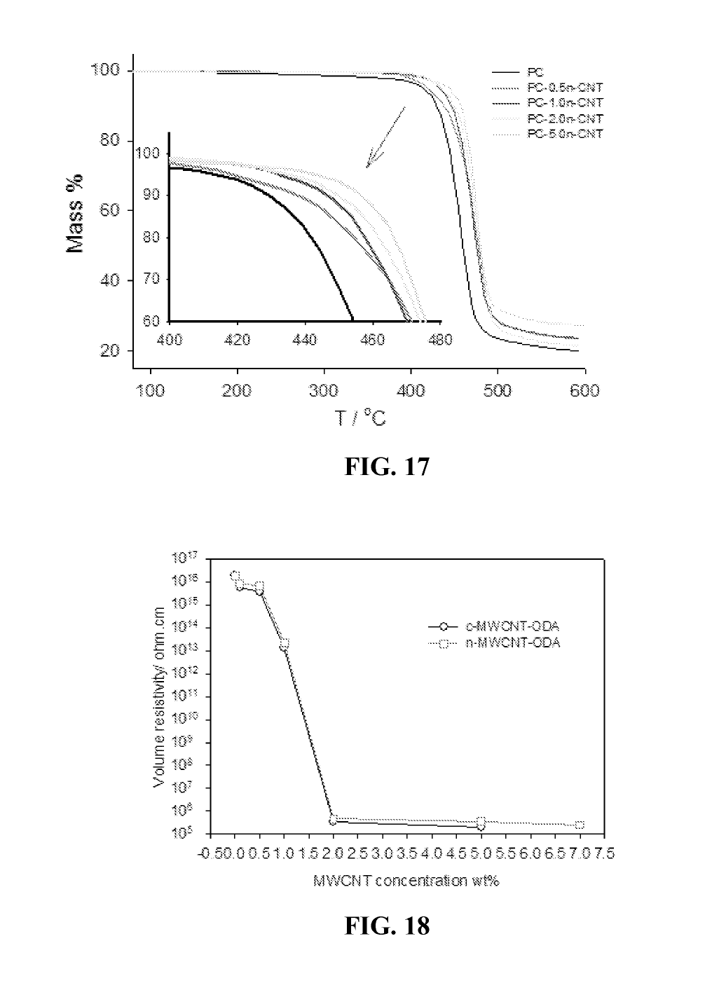

FIG. 13 shows Cryo-fractured FESEM image of the pure PC film (a) and its composite film with 2.0 wt % n-MWCNT-ODA (b); (c) is the image magnification of (b). FIG. 14 shows DMA results of PC and PC nanocomposites with different concentration of non-covalent MWCNTs: (a) storage modulus; (b) tans vs. temperature. FIG. 15 shows strain-stress curves of PC and its nanocomposites. FIG. 16 shows DSC curves of PC and its nanocomposites with different n-MWCNT-ODA concentration. FIG. 17 shows TGA curves of PC and its composites with different n-MWCNT-ODA concentration. FIG. 18 shows volume resistivity of PC and the composites with c-MWCNT-ODA and n-MWCNT-ODA at room temperature. Table 3 shows mechanical properties of neat PC and its composites, and Table 4 shows thermal properties of PC and its composites.

TABLE 3
Mechanical properties of neat PC and its composites.

| | | Storage | Storage | | | | | Elon- |
|---|---|---|---|---|---|---|---|---|
| | | modulus | modulus | | T_{g} by | Tensile | Tensile | gation |
| | | at 50° C. | at 140° C. | | DMA | strength | modulus | at break |
| | | (GPa) | (GPa) | tan δ | (° C.) | (MPa) | (GPa) | (%) |
| n-MWCNT- | 0 | 1.82 | 0.98 | 1.51 | 148.0 | 54.7 | 2.03 | 4.3 |
| ODA wt % | 0.5 | 2.57 | 1.25 | 1.52 | 149.6 | 60.7 | 2.15 | 5.1 |
| | 1.0 | 2.59 | 1.63 | 1.11 | 153.2 | 59.1 | 2.06 | 12 |
| | 2.0 | 2.39 | 1.59 | 1.61 | 157.5 | 55.6 | 1.93 | 16 |
| | 5.0 | 2.39 | 1.60 | 1.52 | 155.7 | 57.3 | 2.09 | 7.2 |

TABLE 4
Thermal properties of PC and its composites

| | Temp. at | Temp. at | | |
|---|---|---|---|---|
| | 10 wt % | 20 wt % | | |
| n-MWCNT- | weight | weight | Temp. at 40 wt % | T_{g} by |
| ODA wt % | loss (° C.) | loss (° C.) | weight loss (° C.) | DSC (° C.) |
| 0 | 429.1 | 442.1 | 464.4 | 143.4 |
| 0.5 | 439.1 | 454.1 | 472.0 | 144.9 |
| 1.0 | 448.7 | 456.3 | 470.2 | 148.2 |
| 2.0 | 450.5 | 461.5 | 474.1 | 148.9 |
| 5.0 | 456.7 | 467.2 | 476.2 | 148.6 |

A number of embodiments of the invention have been described. Nevertheless, it will be understood that various modifications may be made without departing from the spirit and scope of the invention. Accordingly, other embodiments are within the scope of the following claims.

1. A polymer composite comprising a plurality of carbon nanotubes dispersed in a solid polymer matrix.

2. The polymer composite of claim 1, wherein the resistivity of the polymer composite is between 1.0×10⁶ Ω·cm and 1.0×10³ Ω·cm.

3. The polymer composite of claim 1, wherein the percentage of the plurality of carbon nanotubes in the composite is less than 10% by weight.

4. The polymer composite of claim 1, wherein the percentage of the plurality of carbon nanotubes in the composite is less than 2% by weight.

5. The polymer composite of claim 1, wherein the plurality of carbon nanotubes are uniformly dispersed in the polymer.

6. The polymer composite of claim 1, wherein the polymer includes polycarbonate, polyvinyl chloride, polyetherimide, poly(methyl methacrylate), polystyrene, or polyetheretherketone, or a mixture thereof.

7. The polymer composite of claim 1, wherein the plurality of carbon nanotubes are functionalized.

8. The polymer composite of claim 1, wherein the plurality of carbon nanotubes are covalently functionalized.

9. The polymer composite of claim 1, wherein the plurality of carbon nanotubes are non-covalently functionalized.

10. The polymer composite of claim 1, wherein the solid polymer matrix is insulating.

11. A method for forming a solid polymer composite comprising:
dispersing a plurality of carbon nanotubes in a polymer matrix to form a polymer carbon nanotube composite.

12. The method of claim 11, wherein the polymer matrix is insulating.

13. The method of claim 11, wherein the resistivity of the polymer carbon nanotube composite is between 1.0×10⁶ Ω·cm and 1.0×10³ Ω·cm.

14. The method of claim 11, further comprising:
dissolving a polymer into a solvent to form a first solution;
dispersing a plurality of carbon nanotubes containing a carboxyl group into the solvent separately under sonication to form a second solution;
mixing the first solution and the second solution to form a first mixture;
treating the first mixture under sonication; and
drying the first mixture by removing the solvent.

15. The method of claim 11, wherein the plurality of carbon nanotubes are functionalized.

16. The method of claim 15, wherein the functionalization of the plurality of carbon nanotubes is non-covalent.

17. The method of claim 16, further comprising:
contacting the plurality of carbon nanotubes with a compound having an amine moiety to form a second mixture, wherein the amine associates with carboxyl group on the sidewalls of the plurality of carbon nanotubes;
heating the second mixture; and
separating the plurality of carbon nanotubes from the mixture.

18. The method of claim 17, wherein the compound having an amine moiety includes octadecylamine.

19. The method of claim 15, wherein the functionalization of the plurality of carbon nanotubes is covalent.

20. The method of claim 19, further comprising:
contacting the plurality of carbon nanotubes with a compound containing at least one oxide moiety and one halide moiety, wherein the compound reacts with the sidewalls of the plurality of carbon nanotubes to form an acyl halide moiety;
separating the plurality of carbon nanotubes having the acyl halide moiety from the solution;
contacting the separated plurality of carbon nanotubes that contain the acyl halide moiety with a compound having an amine moiety, wherein the acyl halide moiety reacts with the amine moiety to form an amide group on the sidewalls of the plurality of carbon nanotubes.

21.-27. (canceled)
